(19) United States
(12) Patent Application Publication
(10) Pub. No.: US 2026/0247079 A1
(43) Pub. Date: Aug. 20, 2026

(54) Coaxial Speaker

(71) Applicant: AAC Microtech (Changzhou) Co., Ltd., Changzhou City, Jiangsu Province (CN)

(72) Inventors: Zhang Ren, Shenzhen (CN); Zhiwei Zhong, Shenzhen (CN)

(21) Appl. No.: 17/914,354

(22) PCT Filed: Jul. 20, 2022
(86) PCT No.: PCT/CN2022/106759

§ 371 Date: Apr. 29, 2025

(30) Foreign Application Priority Data
Jun. 30, 2022 (CN) 202221696573.9

(51) Int. Cl. H04R 9/04; H04R 1/24; H04R 7/12; H04R 9/02

(52) U.S. Cl. CPC H04R 9/045; H04R 1/24; H04R 7/127; H04R 9/025; H04R 2231/001; H04R 2231/003; H04R 2307/025; H04R 2400/11

(57) ABSTRACT

The present invention provides a coaxial speaker including a frame, a magnetic circuit system, a first vibration system fixed on an inner side of the frame, and a second vibration system fixed on an outer side of the frame. The first vibration system locates coaxially with the second vibration system. The first vibration system includes a first diaphragm and a first voice coil. The second vibration system includes a second diaphragm and a second voice coil. The magnetic circuit system includes a first and a second magnetic gap. The first voice coil partially locates into the first magnetic gap, the second voice coil partially locates into the second magnetic gap. The first diaphragm is used for generating treble sound, the second diaphragm is used for generating bass sound. The second diaphragm is integrally molded by silicone rubber. Bass sound and treble sound form a full-range speaker, providing high-quality sound.

### TECHNICAL FIELD

The present invention relates to the field of sensor, and more particularly, to a coaxial speaker.

### BACKGROUND

Coaxial speaker refers to the speaker with the integration of the treble speaker unit and bass speaker unit, and the treble speaker unit and bass speaker unit are set coaxially. The sound source of the treble speaker unit and bass speaker unit of the coaxial speaker can be located in front of the coaxial speaker, that is, the two speaker units sounding along a same direction. The sound source of the treble unit and bass unit of the coaxial speaker can also be located in front and back of the coaxial speaker respectively, that is, the two speaker units sounding along different directions.

In related art, the treble speaker unit and bass speaker unit of the coaxial speaker usually disposed on a same side of the coaxial speaker, the diaphragm of the treble unit and the diaphragm of bass unit are made of the same material together, so the performance of the coaxial speaker is relatively simple and difficult to control.

Therefore, it is desired to provide a new coaxial speaker which can overcome the above problems.

### SUMMARY

In view of the above, the embodiments of the present invention provide a new coaxial speaker. By the present invention, the diaphragm of the treble unit and the diaphragm of bass unit of the coaxial speaker can be flexibly adjusted. The present disclosure aims to provide a coaxial speaker having a diaphragm of the treble unit and a diaphragm of bass unit can be flexibly adjusted.

The present invention provides a coaxial speaker including a frame, a magnetic circuit system mounted under the frame, a first vibration system fixed on an inner side of the frame, and a second vibration system fixed on an outer side of the frame and surrounding the first vibration system. The first vibration system locates coaxially with the second vibration system. The first vibration system includes a first diaphragm and a first voice coil driving the first diaphragm to generate sounds. The second vibration system includes a second diaphragm and a second voice coil driving the second diaphragm to generate sounds. The magnetic circuit system includes a first magnetic gap and a second magnetic gap located outside of the first magnetic gap. The first voice coil at least partially locates into the first magnetic gap, and the second voice coil at least partially locates into the second magnetic gap. The first diaphragm is used for generating treble sound, and the second diaphragm is used for generating bass sound. The second diaphragm is integrally molded by silicone rubber.

As an improvement, the first diaphragm is integrally molded by silicone rubber.

As an improvement, the first diaphragm comprises a first dome and a first suspension surrounding the first dome, and the first dome and the first suspension are integrally molded by silicone rubber.

As an improvement, the second diaphragm comprises a second suspension, a second dome surrounding the second suspension, and a third suspension surrounding the second dome, and the second suspension, the second dome, and the third suspension are integrally molded.

As an improvement, the second diaphragm comprises a second suspension, a second dome surrounding the second suspension, a third suspension surrounding the second dome, and a voice coil support connecting the second suspension, the second dome, and the third suspension to the second voice coil, the second suspension, the second dome, and the third suspension spaced apart from each other, the second suspension, the second dome, and the third suspension, and the voice coil support being integrally molded.

As an improvement, the magnetic circuit system comprises a magnetic bowl, the magnetic bowl comprising a side wall enclosing a receiving room and a bottom wall bending and extending from an end of the side wall distal to the first vibration system, the magnetic circuit system further comprising a first magnet assembly disposed on one side of the magnetic bowl and a second magnet assembly disposed on the other side of the magnetic bowl, the first magnet assembly comprising a first magnet and a pole plate stacked on the first magnet, the first magnetic gap formed between the first magnet and the side wall of the magnetic bowl, the second magnet assembly comprising a second magnet and a third magnet located outside of the second magnet and forming the second magnetic gap with the second magnet.

As an improvement, the pole plate and the frame are integrally molded.

As an improvement, the coaxial speaker further comprises an inserting member surrounded by the magnetic circuit system, a first circuit board fixed with the inserting member, and a first terminal provided passing through the inserting member, the first voice coil electrically connected to the first circuit board through the first terminal.

As an improvement, the coaxial speaker further comprises a support shelf and an elastic assembly connecting the voice coil support and the support shelf, the elastic assembly comprising a second circuit board and a support membrane connected with the second circuit board, the second voice coil electrically connected to the second circuit board.

As an improvement, the voice coil support comprises a support flat portion attached to the second dome, a first extending portion bending and extending from the support flat portion to the second circuit board and connected to the second circuit board, and a second extending portion bending and extending from the support flat portion to the second voice coil and connected to the second voice coil.

Comparing with the related art, the coaxial speaker of present invention includes a frame, a magnetic circuit system mounted under the frame, a first vibration system fixed on an inner side of the frame, and a second vibration system fixed on an outer side of the frame and surrounding the first vibration system. The first vibration system locates coaxially with the second vibration system. The first vibration system includes a first diaphragm and a first voice coil driving the first diaphragm to generate sounds. The second vibration system includes a second diaphragm and a second voice coil driving the second diaphragm to generate sounds. The magnetic circuit system includes a first magnetic gap and a second magnetic gap located outside of the first magnetic gap. The first voice coil at least partially locates into the first magnetic gap, and the second voice coil at least partially locates into the second magnetic gap. The first diaphragm is used for generating treble sound, and the second diaphragm is used for generating bass sound. The second diaphragm is integrally molded by silicone rubber. The coaxial speaker of the present invention arranges an annular bass vibration system for providing bass sound, a treble vibration system disposed surrounded by the bass vibration system for providing treble sound. Bass sound and treble sound form a full-range speaker, providing high-quality sound. The bass diaphragm is integrally molded by silicone rubber material, and the treble diaphragm also can be integrally molded by silicone rubber material, so that the bass diaphragm and the treble diaphragms can be designed and formed separately. The material and thickness of the treble and bass diaphragm can be adjusted separately according to the different characteristics of bass sound and treble sound, which makes the production of the treble and bass diaphragms more flexible.

### BRIEF DESCRIPTION OF DRAWINGS

In order to more clearly illustrate technical solutions in embodiments of the present disclosure, drawings required in description of the embodiments are briefly described below. Obviously, the drawings in the following description are merely some embodiments of the present disclosure. For a person of ordinary skill in art, other drawings may be obtained according to the drawings without creative efforts.

FIG. 1 is a three-dimensional structural isometric view of a coaxial speaker in accordance with a first embodiment of the present invention.

FIG. 2 is a partially exploded view of the coaxial speaker of FIG. 1.

FIG. 3 is a three-dimensional structural isometric view of partly members of the coaxial speaker of FIG. 1.

FIG. 4 is an exploded view of the coaxial speaker of FIG. 1.

FIG. 5 is an illustrative cross-sectional view of the coaxial speaker taken along line A-A of FIG. 1.

FIG. 6 is an illustrative cross-sectional view of the coaxial speaker taken along line B-B of FIG. 1.

FIG. 7 is illustrative cross-sectional view of the coaxial speaker in accordance with a second embodiment of the present invention.

### DETAILED DESCRIPTION OF EMBODIMENTS

Technical solutions in embodiments of the present disclosure are clearly and completely described below with reference to accompanying drawings in the embodiments of the present disclosure. Obviously, the described embodiments are only a part of the embodiments of the present disclosure, not all of the embodiments. Based on the embodiments of the present disclosure, all other embodiments obtained by a person of ordinary skill in art without creative efforts shall fall within a protection scope of the present disclosure.

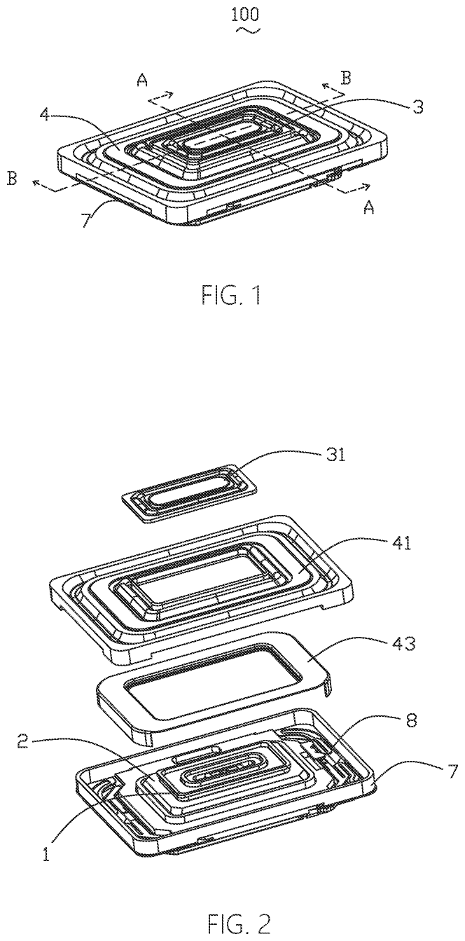

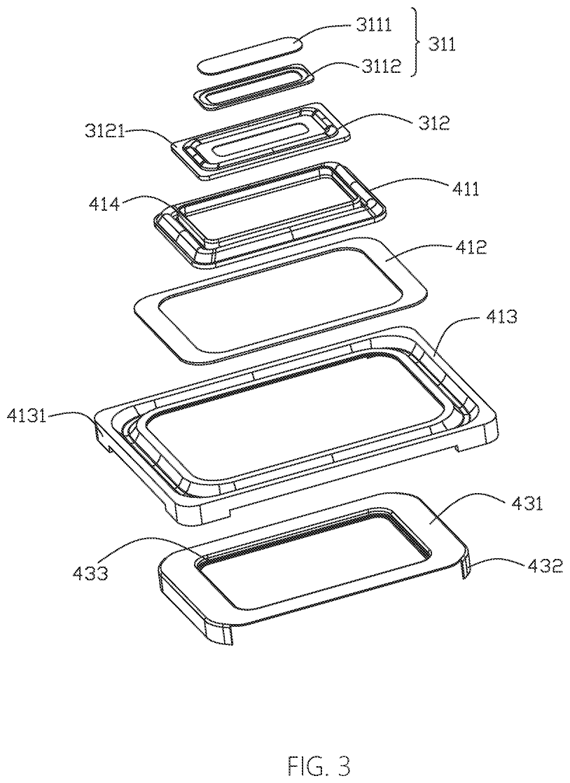

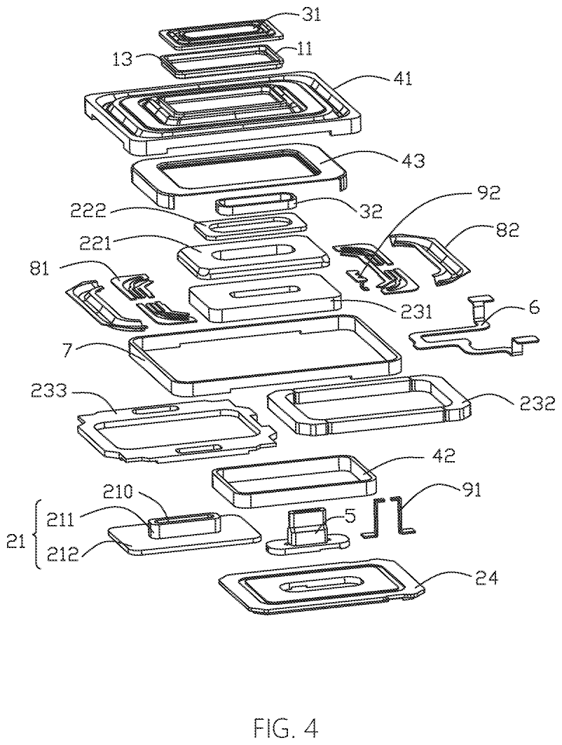

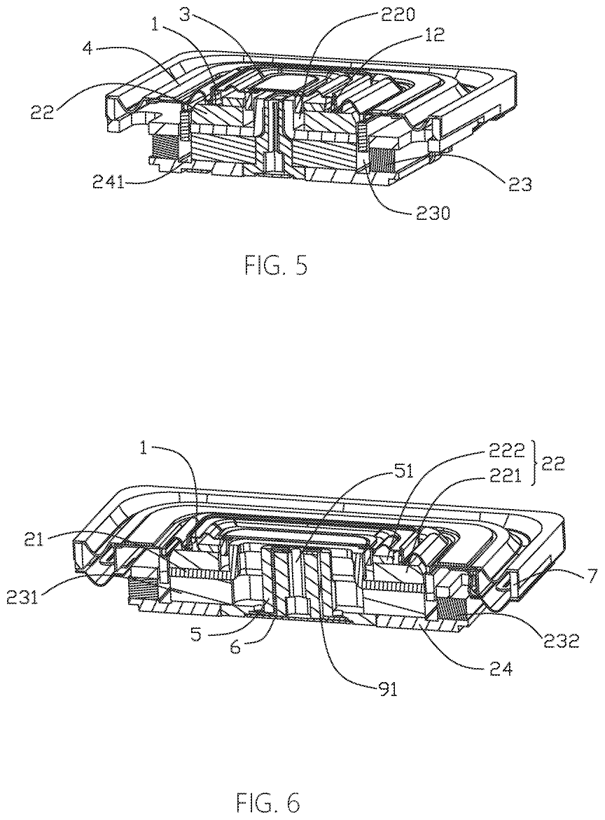

Referring to the FIGS. 1-6, the first embodiment of the present invention provides a coaxial speaker 100. The coaxial speaker 100 includes a frame 1, a magnetic circuit system 2 mounted under the frame 1, a first vibration system 3 fixed on an inner side of the frame 1, a second vibration system 4 fixed on an outer side of the frame 1, an inserting member 5, a first circuit board 6 fixed with the inserting member 5, a support shelf 7, an elastic assembly 8. The second vibration system 4 locates around the first vibration system 3 and is arranged coaxially with the first vibration system 3.

The frame 1 is substantially rectangular, and includes an upper wall 11, a lower wall 12 opposite to the upper wall 11, and an outer wall 13 connecting the upper wall 11 and the lower wall 12. The first vibration system 3 is fixed by covering the upper wall 11 and extending to the outer wall 13 of the frame 1, and the second vibration system 4 is disposed spaced apart from the outer side wall 13.

The magnetic circuit system 2 includes a magnetic bowl 21, a first magnet assembly 22 disposed on one side of the magnetic bowl 21, and a second magnet assembly 23 disposed on the other side of the magnetic bowl 21. The first magnet assembly 22 is arranged coaxially with the second magnet assembly 23. The magnetic bowl 21 includes a side wall 211 enclosing a receiving room 210 and a bottom wall 212 bending and extending from an end of the side wall 211 distal to the first vibration system 3. The first magnet assembly 22 includes a first magnet 221 and a pole plate 222 stacked on the first magnet 221. A space between the first magnet 221 and the side wall 211 of the magnetic bowl 21 forms a first magnetic gap 220. In present embodiment, the pole plate 222 and the frame 1 are separate structures, and the pole plate 222 and the frame 1 can be fixed to each other by attaching against each other. The bottom wall 212 of the magnetic bowl 21 supports the first magnet 221. The second magnet assembly 23 includes a second magnet 231, a third magnet 232 located outside of the second magnet 231 and forming a second magnetic gap 230 with the second magnet 231, and a magnetic guiding plate 233 located on the third magnet 232. The bottom wall 212 of the magnetic bowl 21 is stacked above the second magnet 231. The first magnet 221 is disposed opposite to the second magnet 231. The magnetic circuit system 2 further includes a yoke 24 supporting the second magnet 231 and the third magnet 232. A lower surface of the yoke 24 is flush with the lower surface of the inserting member 5.

The first magnet 221, the second magnet 231 and the third magnet 232 are magnetized along a vibration direction of the coaxial speaker 100, and the first magnet 221 and second magnet 231 are set opposite each other with a same pole, that is, the first magnet 221 and the second magnet 231 are magnetized in opposite directions. The second magnet 231 and third magnet 232 are magnetized in opposite directions. In present embodiment, the first magnet 221, the pole plate 222, the second magnet 231, the third magnet 232, and the magnetic guiding plate 233 can all be hollow annular structures.

The first vibration system 3 includes a first diaphragm 31 and a first voice coil 32 driving the first diaphragm 31 to generate sounds. The first voice coil 32 is at least partially located into the first magnetic gap 220. The first diaphragm 31 is integrally molded by silicone rubber. Of course, the first diaphragm 31 also can be made by a conventional lamination method. The first diaphragm 31 is used for generating treble sound, and a sound direction of the first diaphragm 31 is upward along the vibration direction, that is, the sound direction of the first diaphragm 31 is in front of the coaxial speaker 100. The first diaphragm 31 includes a first dome 311 and a first suspension 312 surrounding the first dome 311. The first dome 311 includes a first dome portion 3111 and a second dome portion 3112 mounted on an outer periphery of the first dome portion 3111. The first suspension 312 includes a first fixing portion 3121. The first fixing portion 3121 is attached on the upper wall 11 of the frame 1 and extending to cover part of the outer wall 13 of the frame 1. The first dome 311 and the first suspension 312 are integrally molded by silicone rubber.

The second vibration system 4 includes a second diaphragm 41, a second voice coil 42 driving the second diaphragm 41 to generate sounds, and a voice coil support 43 connecting the second diaphragm 41 to the second voice coil 42. The second diaphragm 41 is integrally molded by silicone rubber. The second voice coil 42 is at least partially located into the second magnetic gap 230. The second diaphragm 41 is used for generating bass sound, and the sound direction of the second diaphragm 41 is upward along the vibration direction, that is, the sound direction of the second diaphragm 41 is in front of the coaxial speaker 100. The second diaphragm 41 includes a second suspension 411, a second dome 412 surrounding the second suspension 411, and a third suspension 413 surrounding the second dome 412, and an extending arm 414 extending upwardly from a side of the second suspension 411 distal to the second dome 412. One end of the extending arm 414 is suspended. In present embodiment, the second suspension 411, the second dome 412, and a third suspension 413 are disposed spaced apart from each other. The voice coil support 43 is integrally molded with the second suspension 411, the second dome 412, the third suspension 413, and the extending arm 414. The voice coil support 43 connects the second suspension 411, the second dome 412, the third suspension 413, and the extending arm 414 to the second voice coil 42. In other embodiments, the second suspension 411, the second dome 412, the third suspension 413, and the extending arm 414 can connect to each other directly. In this case, the second suspension 411, the second dome 412, the third suspension 413, and the extending arm 414 are integrally molded. One end of the second suspension 411 proximal to the first diaphragm 31 is fixed with the first magnet 221. The third suspension 413 includes a second fixing portion 4131.

A recessing portion 241 is provided on the yoke 24 corresponding to a position of the second voice coil 42 to provide enough vibration space for the second voice coil 42.

The inserting member 5 is disposed in the receiving room 210 enclosed by the side wall 211 of the magnetic bowl 21, the first circuit board 6 is attached on an outer surface of the yoke 24. A first terminal 91 is provided passing through the inserting member 5, and the first terminal 91 is connected with the first circuit board 6. The first voice coil 32 is electrically connected to the first circuit board 6 through the first terminal 91. A leakage channel 51 is provided passing through the inserting member 51.

The support shelf 7 is an annular steel ring, and the second fixing portion 4131 of the third suspension 413 is fixedly connected to the support shelf 7. Specifically, the second fixing portion 4131 covers an upper surface and part of a side surface of the support shelf 7.

The elastic assembly 8 connects the voice coil support 43 and the support shelf 7. The elastic assembly 8 includes a second circuit board 81 and a support membrane 82 connected with the second circuit board 81. The second voice coil 42 is electrically connected to the second circuit board 81. Specifically, the coaxial speaker 100 further includes a second terminal 92 connected to the second circuit board 81, and the second voice coil 42 is electrically connected to the second circuit board 81 through the second terminal 92. In this embodiment, the number of the elastic assemblies 8 is two, and each elastic assembly 8 is arranged in a direction of a short axis of the coaxial speaker 100. In other embodiments, the position of the elastic assembly 8 may be determined according to the situation.

The voice coil support 43 includes a support flat portion 431 attached to the second dome 412, a first extending portion 432 bending and extending from the support flat portion 431 to the second circuit board 81 and connected to the second circuit board 81, and a second extending portion 433 bending and extending from the support flat portion 431 to the second voice coil 42 and connected to the second voice coil 42.

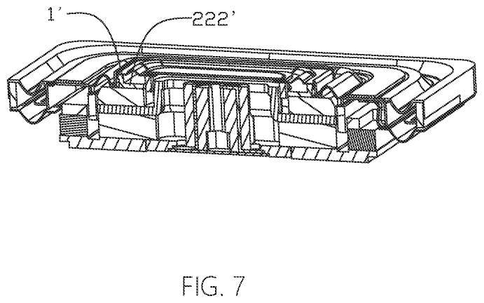

Referring to FIG. 7, the structure of the coaxial speaker in second embodiment of present invention is substantially the same as that of the coaxial speaker 100 in the first embodiment. The difference is that the pole core 222′ and the frame 1′ of the coaxial speaker in the second embodiment are integrally molded.

Comparing with the related art, in the coaxial speaker of present invention, the coaxial speaker includes a frame, a magnetic circuit system mounted under the frame, a first vibration system fixed on an inner side of the frame, and a second vibration system fixed on an outer side of the frame and surrounding the first vibration system. The first vibration system locates coaxially with the second vibration system. The first vibration system includes a first diaphragm and a first voice coil driving the first diaphragm to generate sounds. The second vibration system includes a second diaphragm and a second voice coil driving the second diaphragm to generate sounds. The magnetic circuit system includes a first magnetic gap and a second magnetic gap located outside of the first magnetic gap. The first voice coil at least partially locates into the first magnetic gap, and the second voice coil at least partially locates into the second magnetic gap. The first diaphragm is used for generating treble sound, and the second diaphragm is used for generating bass sound. The second diaphragm is integrally molded by silicone rubber. The coaxial speaker of the present invention arranges an annular bass vibration system for providing bass sound, a treble vibration system disposed surrounded by the bass vibration system for providing treble sound. Bass sound and treble sound form a full-range speaker, providing high-quality sound. The bass diaphragm is integrally molded by silicone rubber material, and the treble diaphragm also can be integrally molded by silicone rubber material, so that the bass diaphragm and the treble diaphragms can be designed and formed separately. The material and thickness of the treble and bass diaphragm can be adjusted separately according to the different characteristics of bass sound and treble sound, which makes the production of the treble and bass diaphragms more flexible.

The above are only the embodiments of the present disclosure. It should be noted that, for the person of ordinary skill in the art, improvements are made without departing from concepts of the present disclosure, but these are all within the protection scope of the present disclosure.
Summary
Technical problem
Solutions for the technical problem
Beneficial Effects of the present disclosure

What is claimed is:

1. A coaxial speaker, comprising:
a frame;
a magnetic circuit system mounted under the frame, the magnetic circuit system comprising a first magnetic gap and a second magnetic gap located outside of the first magnetic gap;
a first vibration system fixed on an inner side of the frame, the first vibration system comprising a first diaphragm and a first voice coil driving the first diaphragm to generate sounds, the first voice coil at least partially located into the first magnetic gap, the first diaphragm used for generating treble sound; and
a second vibration system fixed on an outer side of the frame and around the first vibration system, the first vibration system located coaxially with the second vibration system, the second vibration system comprising a second diaphragm and a second voice coil driving the second diaphragm to generate sounds, the second voice coil at least partially located into the second magnetic gap, the second diaphragm used for generating bass sound, the second diaphragm integrally molded by silicone rubber.

2. The coaxial speaker as described in claim 1, wherein the first diaphragm is integrally molded by silicone rubber.

3. The coaxial speaker as described in claim 2, wherein the first diaphragm comprises a first dome and a first suspension surrounding the first dome, and the first dome and the first suspension are integrally molded.

4. The coaxial speaker as described in claim 1, wherein the second diaphragm comprises a second suspension, a second dome surrounding the second suspension, and a third suspension surrounding the second dome, and the second suspension, the second dome, and the third suspension are integrally molded.

5. The coaxial speaker as described in claim 1, wherein the second diaphragm comprises a second suspension, a second dome surrounding the second suspension, a third suspension surrounding the second dome, and a voice coil support connecting the second suspension, the second dome, and the third suspension to the second voice coil, the second suspension, the second dome, and the third suspension spaced apart from each other, the second suspension, the second dome, the third suspension, and the voice coil support being integrally molded.

6. The coaxial speaker as described in claim 1, wherein the magnetic circuit system comprises a magnetic bowl, the magnetic bowl comprising a side wall enclosing a receiving room and a bottom wall bending and extending from an end of the side wall distal to the first vibration system, the magnetic circuit system further comprising a first magnet assembly disposed on one side of the magnetic bowl and a second magnet assembly disposed on the other side of the magnetic bowl, the first magnet assembly comprising a first magnet and a pole plate stacked on the first magnet, the first magnetic gap formed between the first magnet and the side wall of the magnetic bowl, the second magnet assembly comprising a second magnet and a third magnet located outside of the second magnet and forming the second magnetic gap with the second magnet.

7. The coaxial speaker as described in claim 6, wherein the pole plate and the frame are integrally molded.

8. The coaxial speaker as described in claim 5, wherein the coaxial speaker further comprises an inserting member surrounded by the magnetic circuit system, a first circuit board fixed with the inserting member, and a first terminal provided passing through the inserting member, the first voice coil electrically connected to the first circuit board through the first terminal.

9. The coaxial speaker as described in claim 8, wherein the coaxial speaker further comprises a support shelf and an elastic assembly connecting the voice coil support and the support shelf, the elastic assembly comprising a second circuit board and a support membrane connected with the second circuit board, the second voice coil electrically connected to the second circuit board.

10. The coaxial speaker as described in claim 9, wherein the voice coil support comprises a support flat portion attached to the second dome, a first extending portion bending and extending from the support flat portion to the second circuit board and connected to the second circuit board, and a second extending portion bending and extending from the support flat portion to the second voice coil and connected to the second voice coil.
